(19) United States
(12) Patent Application Publication
(10) Pub. No.: US 2019/0066369 A1
(43) Pub. Date: Feb. 28, 2019

(54) Method and System for Quickly Generating a Number of Face Images Under Complex Illumination

(71) Applicant: ULSee Inc., Taipei City (TW)

(72) Inventor: Bao-Yun Peng, Taipei City (TW)

(21) Appl. No.: 15/818,879

(22) Filed: Nov. 21, 2017

(30) Foreign Application Priority Data
Aug. 31, 2017 (CN) 201710769583.8

(51) Int. Cl. G06T 15/50; G06T 15/04; G06T 19/20; G06T 3/40; G06T 11/60

(52) U.S. Cl. CPC G06T 15/506; G06T 15/04; G06T 19/20; G06T 2200/08; G06T 11/60; G06T 2219/2004; G06T 2219/2016; G06T 3/4053

(57) ABSTRACT

A method for quickly generating a number of face images under complex illumination includes the steps: providing at least one two-dimensional face image; creating a number of key points on the two-dimensional face image in order to obtain a three-dimensional face shape; replenishing the two-dimensional face image with an invisible portion; performing a texture mapping on the three-dimensional face shape in order to obtain a three-dimensional face; placing the three-dimensional face at an origin position of a three-dimensional coordinate and separately rotating the three-dimensional face with three coordinate axes as a center, and setting up different light sources in different coordinates of the three-dimensional coordinates to complete light rendering; and placing the three-dimensional face at the origin position of the three-dimensional coordinate and separately rotating the three-dimensional face with three coordinate axes as the center, and photographing the three-dimensional face from different angles in order to acquire a plurality of two-dimensional face images having light information. The beneficial effect of the present disclosure is to automatically generate a large number of face images under complex illumination.

### FIELD OF THE DISCLOSURE

The present disclosure relates to methods and systems for automatically generating face images, and more particularly to methods and systems for quickly generating a large number of face images under complex illumination.

### BACKGROUND OF THE INVENTION

When using deep neural networks to perform face recognition, a large acquisition of face images with labels is required, wherein these acquired face images are used to train neural networks. However, collecting these face images manually takes lots of manpower and time, so it is very valuable to collect or generate the face images through automation.

At present, there are two types of automatic generation of face images. The first method is to synthesize face images through 3D models and texture mappings. This method needs to obtain a face image and a 3D model corresponding to the face image first, however, it's not easy to obtain a 3D model for a face, and the cost is quite high.

The second method is to create a 3D face image from one or more 3D face images, and perform a texture mapping in order to complete the 3D model. The main means of obtaining 3D face images from 2D face images include 3DMM, stereo photo brightness methods, and deep learning methods. After the 3D model is obtained, a large number of different types of 2D face images are generated by applying various modifications to the 3D model, such as rotation, or projection of the 3D model to the 2D face images.

However, the existing methods of automatically generating 2D face images can generate 2D face images that conform to face features, but these 2D face images fail to consider illumination factors, wherein the illumination factors have a great influence on the image generation. If the illumination factors of the generated images have insufficient differentiation, the performance of these generated images on deep learning will be limited.

If the provided face image is not a direct face image or the face of the face image is blocked (that is to say, the face image has an invisible region), it will cause loss of texture in the partial region of the 3D image when performing a texture mapping on the 3D face image. If t the provided face image has a low resolution, the automatically-generated face image will also have a low resolution.

Hence, how to provide methods and systems capable of solving the above-mentioned problems has become an important topic for the person skilled in the art.

### SUMMARY OF THE INVENTION

In view of the above-mentioned problems, methods and systems for quickly generating a number of face images under complex illumination are provided in the present disclosure, which can automatically and quickly generating a large number of face images under complex illumination.

It is one objective of the present disclosure to provide a method for quickly generating a number of face images under complex illumination.

According to one exemplary embodiment of the present disclosure, a method for quickly generating a number of face images under complex illumination is provided. The method includes the following steps: S10: providing at least one two-dimensional face image; S20: creating a number of key points on the two-dimensional face image in order to obtain a three-dimensional face shape; S30: replenishing the two-dimensional face image with an invisible portion; S40: performing a texture mapping on the three-dimensional face shape in order to obtain a three-dimensional face; S50: placing the three-dimensional face at an origin position of a three-dimensional coordinate and separately rotating the three-dimensional face with three coordinate axes as a center, and setting up different light sources in different coordinates of the three-dimensional coordinates to complete light rendering; and S60: placing the three-dimensional face at the origin position of the three-dimensional coordinate and separately rotating the three-dimensional face with three coordinate axes as the center, and photographing the three-dimensional face from different angles in order to acquire a plurality of two-dimensional face images having light information.

In one example, the method further includes the following step the step S20 further comprises: fitting the key points to obtain the three-dimensional face shape.

In one example, the method further comprising the following step: S70: adding corresponding backgrounds to the plurality of two-dimensional face images having light information.

In one example, the step S30 further comprises: using a super-resolution reconstruction algorithm to replenish the two-dimensional face image with the invisible portion.

In one example, in the step S30, the invisible portion is obtained from non-front side images corresponding to the two-dimensional face image, and the super-resolution reconstruction algorithm is performed on the non-front side images corresponding to the two-dimensional face image for replenishing the two-dimensional face image.

In one example, the step S40 further comprises: obtaining a material from the two-dimensional face image, and using the obtained material to perform the texture mapping on the three-dimensional face shape.

It is one objective of the present disclosure to provide a system for quickly generating a number of face images under complex illumination.

According to one exemplary embodiment of the present disclosure, a system for quickly generating a number of face images under complex illumination is provided. The system includes an image providing module, three-dimensional face shape obtaining module, a replenishing module, a texture mapping module, a texture mapping module, and an image creating module. The image providing module is used for providing at least one two-dimensional face image. The three-dimensional face shape obtaining module is used for creating a number of key points on the two-dimensional face image in order to obtain a three-dimensional face shape. The replenishing module is used for replenishing the two-dimensional face image with an invisible portion. The texture mapping module is used for performing a texture mapping on the three-dimensional face shape in order to obtain a three-dimensional face. The light rendering module is used for placing the three-dimensional face at an origin position of a three-dimensional coordinate and separately rotating the three-dimensional face with three coordinate axes as a center, and setting up different light sources in different coordinates of the three-dimensional coordinates to complete light rendering. The image creating module is used for placing the three-dimensional face at the origin position of the three-dimensional coordinate and separately rotating the three-dimensional face with three coordinate axes as the center, and photographing the three-dimensional face from different angles in order to acquire a plurality of two-dimensional face images having light information.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating the procedures of a method for quickly generating a number of face images under complex illumination according to an embodiment of the present disclosure.

FIG. 2 is a schematic diagram of a two-dimensional face image and key points.

FIG. 3 is a schematic diagram for replenishing a two-dimensional face image with an invisible portion.

FIG. 4 is a schematic diagram of a three-dimensional face and three-dimensional coordinates.

FIG. 5 is a schematic diagram of capturing a three-dimensional face.

### DESCRIPTION OF THE PREFERRED EMBODIMENTS

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

A method for quickly generating a number of face images under complex illumination is provided in the present disclosure, which inputs a plurality of two-dimensional face images, and uses a super-resolution algorithm for reconstruction to create three-dimensional face images. After that, a texture mapping and a light rendering are performed on the three-dimensional face in order to acquire a plurality of two-dimensional face images having light information. Through the method of the present invention, a large number of two-dimensional face images having light information can be automatically created for usage in deep neural network learning.

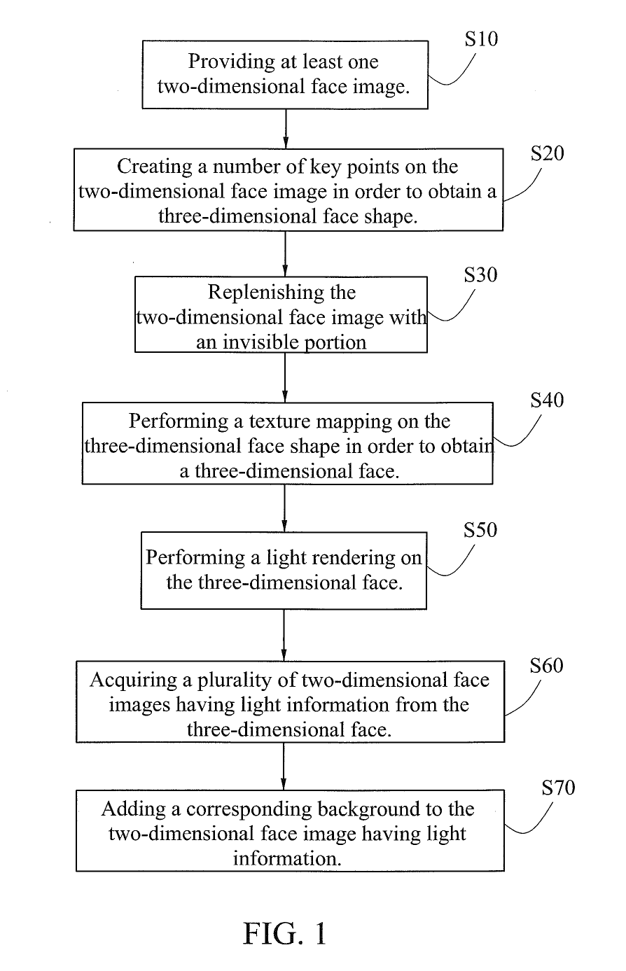

Please refer to FIG. 1. FIG. 1 is a flowchart illustrating the procedures of a method for quickly generating a number of face images under complex illumination according to an embodiment of the present disclosure. First, at step S10, at least one two-dimensional face image 10 is provided. In a preferred embodiment, the two-dimensional face image 10 is a direct face image, and a side face two-dimensional face image 10 can also be used for reconstruction and replenishment in the subsequent steps.

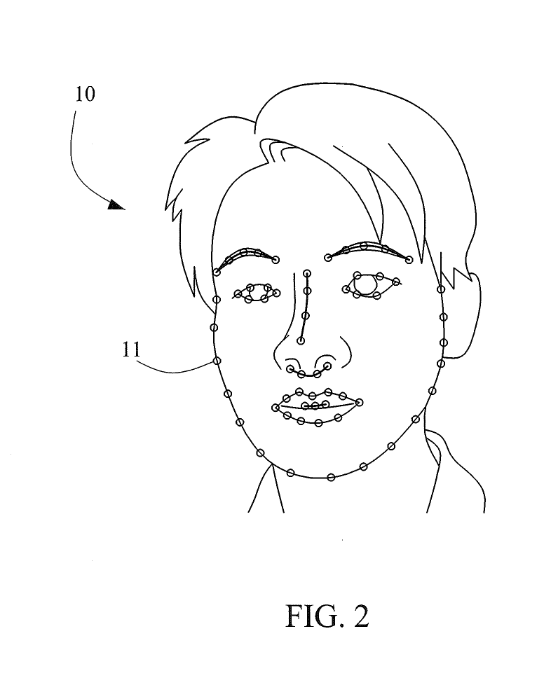

Please refer to FIG. 2. FIG. 2 is a schematic diagram of a two-dimensional face image and key points. In step S20, a number of key points 11 are created on the two-dimensional face image 10 in order to obtain a three-dimensional face shape 20. In this embodiment, totally 68 key points 11 are created on the two-dimensional face image 10, wherein the key points 11 are mainly located on main features of the face, such as facial features and facial striations. In Step S20, the key points 11 are fitted to obtain the three-dimensional face shape 20, which uses a distance that the key points 11 and the three-dimensional face shape 20 obtained by fitting projected onto the image for adjusting the fitting coefficient so as to adjust the face shape 20. This process is repeated until that the key points of the three-dimensional face shape 20 projected onto the two-dimensional face image 10 and the detected key points are basically the same.

In the step S30, the two-dimensional face image 10 is replenished with an invisible portion. The so-call invisible portion refers to the obscured portion of the two-dimensional face image 10 or the side face two-dimensional face image 10. In the step S30, a super-resolution reconstruction algorithm is used to replenish the two-dimensional face image 10 with the invisible portion, for example, frontalization or inpainting method may be adopted for replenishing the two-dimensional face image 10 with the invisible portion.

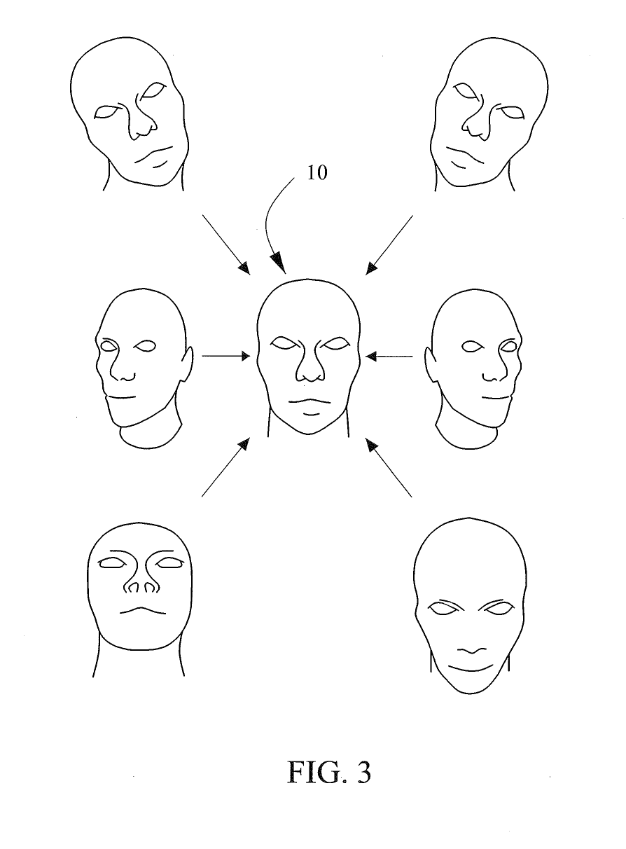

Please refer to FIG. 3. FIG. 3 is a schematic diagram for replenishing a two-dimensional face image with an invisible portion. In one embodiment, a plurality of side face two-dimensional face images 12 are adopted for replenishing the direct face two-dimensional face image 10 with the invisible portion, so as to create high-resolution face images.

The deep learning method is adopted for performing a super-resolution on the low resolution human images. The purpose of the super-resolution reconstruction algorithm is to improve the resolution of the image while minimizing the reduction in sharpness, for preserving the original image information to the maximum extent and providing clearer edges and details.

Next, in Step S40, a texture mapping is performed on the three-dimensional face shape 20 created in the step S20 in order to obtain a three-dimensional face 20a, wherein the main source of the texture mapping material is from the two-dimensional face image 10 replenished in the step S30. The three-dimensional face 20a after performing the texture mapping is a 3D model with face colors and facial striations.

In Step S50, after the three-dimensional face 20a is complete, a light rendering is performed on the three-dimensional face 20a. The light rendering is to sequentially illuminate the three-dimensional face 20a from different angles, so that the three-dimensional face 20a produces different shadow effects with regards to light sources from different directions.

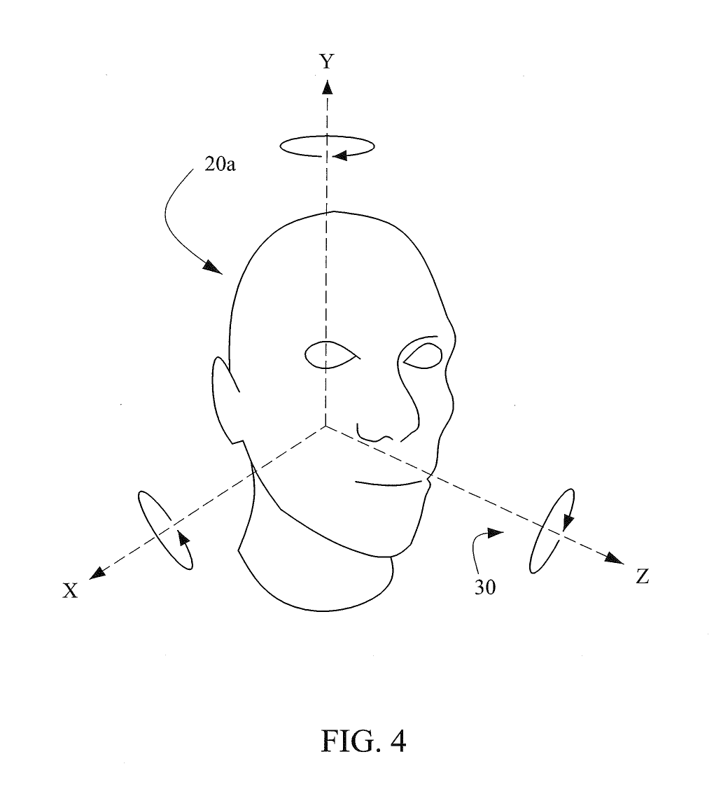

Please refer to FIG. 4. FIG. 4 is a schematic diagram of a three-dimensional face and three-dimensional coordinates. In one embodiment, the three-dimensional face 20a is placed in a three-dimensional coordinate 30, and especially, the three-dimensional face 20a is placed at an origin position of a three-dimensional coordinate 30. Further, the horizontal direction of the three-dimensional face 20a is parallel to the X-axis, the vertical direction of the three-dimensional face 20a is parallel to the Y-axis, and the front-rear direction of the three-dimensional face 20a is parallel to the Z-axis. Next, the three-dimensional face 20a is separately rotated with the three coordinate axes X-axis, Y-axis, and Z-axis of the three-dimensional coordinate 30 as a center, and different light sources are set up in any of the three coordinate axes X-axis, Y-axis, and Z-axis of the three-dimensional coordinates 30 to complete light rendering on the three-dimensional face 20a.

In Step S60, after completing light rendering on the three-dimensional face 20a, a large number of two-dimensional face images 10 having light information may be acquired from the three-dimensional face 20a. At this step, the three-dimensional face 20a has a lighting effect after performing the light rendering. Therefore, the three-dimensional face 20a can be placed at the origin position of the three-dimensional coordinate 30, the three-dimensional face 20a is rotated with the three coordinate axes X-axis, Y-axis, and Z-axis as the center, respectively, and the three-dimensional face 20a is photographed from different angles in order to acquire a plurality of two-dimensional face images 10 having light information.

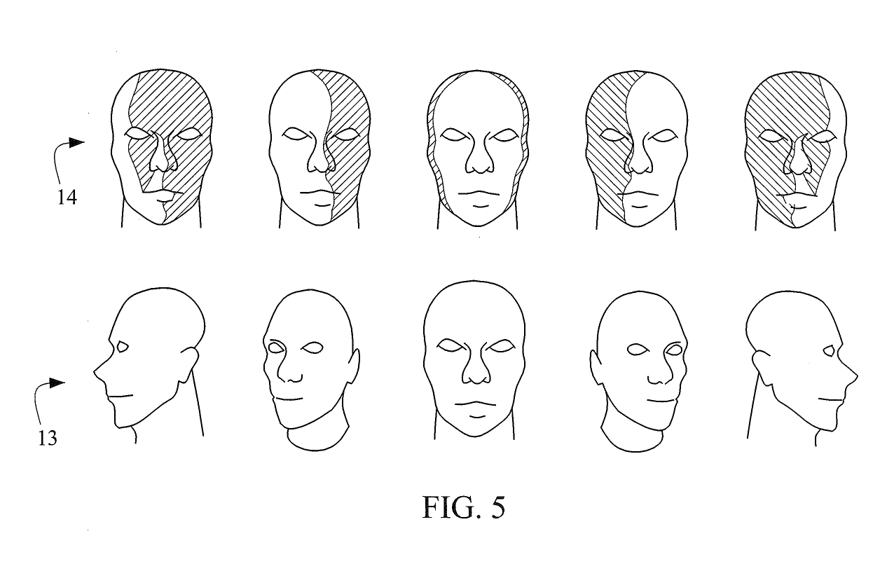

Please refer to FIG. 5. FIG. 5 is a schematic diagram of capturing a three-dimensional face. At the step S60, a plurality of different two-dimensional face images 10 are captured from the three-dimensional face 20a. For example, an image group 14 includes a plurality of direct face two-dimensional face images 10. If light sources are provided from different angles, a series of two-dimensional face images 10 are captured one by one. For example, an image group 13 includes a plurality of two-dimensional face-images 10 captured from different angles. The image groups 13 and 14 are only examples of image capturing, wherein the light source providing angle and the image capturing angle can be any direction, which is not limited to FIG. 5.

A plurality of two-dimensional face images 10 having light information can be obtained by performing a light rendering on the three-dimensional face 20a. Next, a corresponding background may be added to the two-dimensional face images 10 having light information, wherein the added background has the light information corresponding to the two-dimensional face images 10, that is to say, the light source direction of the background is the same as the light source direction of the two-dimensional face image 10. After adding the background to the two-dimensional face image 10 having the light information, the image representation will be more complete, which is beneficial to deep neural network learning.

The method for rapidly generating a large number of face images under complex illumination of the present invention creates a three-dimensional face shape 20 by inputting a basic two-dimensional face image 10 and reconstructing the two-dimensional face image 10 through a super-resolution algorithm, uses a material obtained from the two-dimensional face image 10 to perform a texture mapping on the three-dimensional face shape 20, and performs a light rendering on the three-dimensional face 20a. After that, since the three-dimensional face 20a can be rotated freely in the three-dimensional coordinate 30 and can be illuminated from different directions, a large number of face images with complex illumination can be automatically generated and the background of the corresponding light can be given in order to make the images more realistic. This helps deep neural network learning and enhances the efficiency of face recognition.

Reference in the specification to “one example” or “an example” means that a particular feature, structure, or characteristic described in connection with the example is included in at least an implementation. The appearances of the phrase “in one example” in various places in the specification are not necessarily all referring to the same example. Thus, although examples have been described in language specific to structural features and/or methodological acts, it is to be understood that claimed subject matter may not be limited to the specific features or acts described. Rather, the specific features and acts are disclosed as sample forms of implementing the claimed subject matter.

The above are only preferred examples of the present disclosure is not intended to limit the present disclosure within the spirit and principles of the present disclosure, any changes made, equivalent replacement, or improvement in the protection of the present disclosure should contain within the range.

Those skilled in the art will readily observe that numerous modifications and alterations of the device and method may be made while retaining the teachings of the invention. Accordingly, the above disclosure should be construed as limited only by the meters and bounds of the appended claims.

What is claimed is:

1. A method for quickly generating a number of face images under complex illumination, comprising:
S10: providing at least one two-dimensional face image;
S20: creating a number of key points on the two-dimensional face image in order to obtain a three-dimensional face shape;
S30: replenishing the two-dimensional face image with an invisible portion;
S40: performing a texture mapping on the three-dimensional face shape in order to obtain a three-dimensional face;
S50: placing the three-dimensional face at an origin position of a three-dimensional coordinate and separately rotating the three-dimensional face with three coordinate axes as a center, and setting up different light sources in different coordinates of the three-dimensional coordinate to complete light rendering; and
S60: placing the three-dimensional face at the origin position of the three-dimensional coordinate and separately rotating the three-dimensional face with three coordinate axes as the center, and photographing the three-dimensional face from different angles in order to acquire a plurality of two-dimensional face images having light information.

2. The method for quickly generating a number of face images under complex illumination according to claim 1, wherein the step S20 further comprises:
fitting the key points to obtain the three-dimensional face shape.

3. The method for quickly generating a number of face images under complex illumination according to claim 1, further comprising the following step:
S70: adding corresponding backgrounds to the plurality of two-dimensional face images having light information.

4. The method for quickly generating a number of face images under complex illumination according to claim 1, wherein the step S30 further comprises:
using a super-resolution reconstruction algorithm to replenish the two-dimensional face image with the invisible portion.

5. The method for quickly generating a number of face images under complex illumination according to claim 4, wherein in the step S30, the invisible portion is obtained from non-front side images corresponding to the two-dimensional face image, and the super-resolution reconstruction algorithm is performed on the non-front side images corresponding to the two-dimensional face image for replenishing the two-dimensional face image.

6. The method for quickly generating a number of face images under complex illumination according to claim 1, wherein the step S40 further comprises:
obtaining a material from the two-dimensional face image, and using the obtained material to perform the texture mapping on the three-dimensional face shape.

7. A system for quickly generating a number of face images under complex illumination, the system comprising:
an image providing module, used for providing at least one two-dimensional face image;
a three-dimensional face shape obtaining module, used for creating a number of key points on the two-dimensional face image in order to obtain a three-dimensional face shape;
a replenishing module, used for replenishing the two-dimensional face image with an invisible portion;
a texture mapping module, used for performing a texture mapping on the three-dimensional face shape in order to obtain a three-dimensional face;
a light rendering module, used for placing the three-dimensional face at an origin position of a three-dimensional coordinate and separately rotating the three-dimensional face with three coordinate axes as a center, and setting up different light sources in different coordinates of the three-dimensional coordinates to complete light rendering; and
an image creating module, used for placing the three-dimensional face at the origin position of the three-dimensional coordinate and separately rotating the three-dimensional face with three coordinate axes as the center, and photographing the three-dimensional face from different angles in order to acquire a plurality of two-dimensional face images having light information.

8. The system for quickly generating a number of face images under complex illumination according to claim 7, wherein the three-dimensional face shape obtaining module is further used for fitting the key points to obtain the three-dimensional face shape.

9. The system for quickly generating a number of face images under complex illumination according to claim 7, further comprising:
a background adding module, used for adding corresponding backgrounds to the plurality of two-dimensional face images having light information.

10. The system for quickly generating a number of face images under complex illumination according to claim 7, wherein the replenishing module is used for using a super-resolution reconstruction algorithm to replenish the two-dimensional face image with the invisible portion.

11. The system for quickly generating a number of face images under complex illumination according to claim 10, wherein the invisible portion is obtained from non-front side images corresponding to the two-dimensional face image, and the replenishing module is used for performing the super-resolution reconstruction algorithm on the non-front side images corresponding to the two-dimensional face image for replenishing the two-dimensional face image.

12. The system for quickly generating a number of face images under complex illumination according to claim 7, wherein the texture mapping module is used for obtaining a material from the two-dimensional face image, and using the obtained material to perform the texture mapping on the three-dimensional face shape.
